(19) United States
(12) Patent Application Publication
(10) Pub. No.: US 2006/0072569 A1
(43) Pub. Date: Apr. 6, 2006

(54) Network address translation protocol for transmission control protocol connections

(75) Inventors: Jeffrey L. Eppinger, Carnegie, PA (US); Mukund Gopalan, Seattle, WA (US); Kamal Saurabh, Seattle, WA (US)

Correspondence Address: THE WEBB LAW FIRM, P.C., 700 KOPPERS BUILDING, 436 SEVENTH AVENUE, PITTSBURGH, PA, 15219, US

(73) Assignee: Wizzysoft Corporation, Carnegie, PA (US)

(21) Appl. No.: 11/243,448

(22) Filed: Oct. 4, 2005

Related U.S. Application Data
(60) Provisional application No. 60/615,704, filed on Oct. 4, 2004.

(51) Int. Cl. H04L 12/56

(52) U.S. Cl. 370/389; 370/401

(57) ABSTRACT

The present invention is directed to a computer-implemented Network Address Translation (NAT) traversal method for establishing a direct connection from a first entity to a second entity, including a recipient peer communicating through a recipient NAT box. The method includes the steps of: (a) initiating an outbound TCP communication by the recipient peer through the recipient NAT box to the first entity; (b) creating, by the recipient NAT box, a mapping for use in forwarding requests received at the IP address and port of recipient NAT box to the IP address and port of the recipient peer; (c) rejecting the communication by the first entity; (d) initiating a TCP communication by the first entity, at the IP address and port of the first entity, with the recipient peer, at the IP address and port of the recipient peer, through the recipient NAT box, at the IP address and port of the recipient NAT box utilizing the mapping, thereby establishing a direct communication between the first entity and the recipient peer.

### CROSS REFERENCE TO RELATED APPLICATIONS

This application claims priority from U.S. Provisional Patent Application No. 60/615,704, filed Oct. 4, 2004.

### BACKGROUND OF THE INVENTION

1. Field of the Invention

The present invention relates generally to making Transmission Control Protocol (TCP) connections on a network, such as the Internet and, in particular, to a method of making TCP connections across Network Address Translation (NAT) boxes, a method of establishing an outbound TCP communication from a recipient peer and a method of registering at least one peer with a control server.

2. Description of the Related Art

As computers are increasingly being attached to the Internet, we are running out of Internet Protocol (IP) addresses. The most used type of IP addresses is IPv4. IPv4 addresses are 4 bytes long, which permits approximately 4 billion addresses. Unfortunately, the addresses are allocated in blocks, so while many addresses are not used, they cannot be readily allocated to others. Several developments are underway to address this problem. Two current developments include: (1) IPv6 (16 bytes long), which is not widely used; and (2) Network Address Translation (NAT) boxes, which are used extensively, but provide limited support for inbound communication requests.

With respect to these NAT boxes, and for newly emerging peer-to-peer (P2P) applications, it is important to permit inbound connections to computers attached to the Internet via these NAT boxes. This is especially important since both peers in a P2P application may be behind different NAT boxes. Solving this problem would permit P2P applications behind NAT boxes to directly connect to each other without sending all their communications through intermediaries. Examples of popular P2P applications include P2P file-sharing and P2P telephony. It is likely that additional P2P applications will be created in this emerging area.

Current P2P applications solve the problem of connecting to a peer computer behind an NAT box (an NATed peer) in one of several ways. First, P2P communications are routed through relay servers provided by the application provider (e.g., Groove). However, this is not scalable. The application providers must increase network bandwidth to the relay servers as application usage grows or has poor performance. Another solution includes deputizing non-NATed computers running the P2P application to route P2P connections for NATed computers (e.g., Skype). This solution gives rise to the problem that there may not be enough non-NATed computers running the application. Also, these non-NATed users may not want to utilize their network and CPU bandwidth to help out. Yet another solution includes requiring the user to specially configure their NAT boxes to direct inbound requests to a certain computer behind the NAT. This proves too confusing for many users. Also, the user many not have access to configure the NAT box. Additionally, this usually only allows inbound access to one computer behind the NAT for each particular application.

The various available technology protocols and services, including the associated terms and abbreviations as used herein, are as follows:

IP—The basic communication protocol upon which Internet traffic flows is called IP (the Internet Protocol). IP provides routing of messages between computers on a best effort basis. Messages can be lost during transmission and can arrive out of order. Higher-level protocols address this.

IP Addresses—IP provides addressing of computers on the network using a 4-byte network address, also called an IPv4 address, such as 66.93.61.211. There are over 4 billion possible addresses. Unfortunately, the addresses are allocated in blocks, so while many addresses are not used they cannot be allocated to others. (See IPv6, below.)

Ports—Ports are used to represent network connections on a computer. While a computer typically has only one physical network connection running on one IP address, many applications running on a computer may need to access the network concurrently. Each application can have several virtual network connections, and each connection is represented by the computer's IP address and a port number between 1 and 65535. When an application running on computer A wants to communicate with another application running on computer B, it sends data from A's IP address using port X to B's IP address using port J. This is denoted as sending data from A:X to B:J.

UDP—Layered on top of IP is the User Datagram Protocol (UDP), which is also known as the Unreliable Datagram Protocol. It permits applications to send messages from a local IP address and port to a remote IP address and port. (For local communication, the remote and local IP addresses are the same.) But, messages may be lost in transmission without the sender receiving any error.

TCP—Also layered on top of IP is the Transmission Control Protocol (TCP). It permits an application (the Client or the Initiator) to open a connection to another application (the Server or Receiver) running on (the same or) another computer over which a stream of bytes can be sent in either direction. The connection receiver is determined by its IP address and port.

DNS—The Domain Name Service (DNS) provides a way to refer to computers using symbolic names (Domain Names), such as wizzysoft.com, rather than IP addresses. Given a symbolic domain name, DNS provides the IP address. Many IP addresses can have the same Domain Name. In this case, DNS provides the addresses in a round-robin ordering so that connections will be spread across the various addresses.

The IPv6 protocol was developed as a replacement for IPv4. IPv6 addresses are 16 bytes long, permitting enough addresses to allow every person on earth to have a different address for everything they will ever own. However, the problem with IPv6 is that its uptake has been very slow. IPv6 is eight years old, but still has not been broadly adopted, especially in the United States. IPv6 still has several shortcomings, primarily in terms of hardware support for network routing and network security. Also, many network applications do not support IPv6.

As discussed above, NAT boxes are commonly used on IPv4 networks to allow many computers to share the same public IPv4 address. In this application, homes and small businesses purchase Wide Area Network (WAN) service from a DSL or Cable Internet Service Provider (ISP). In particular, the home or small business will receive one public IP address, and then hook the NAT box up to the WAN. At the other end of the NAT box is a Local Area Network (LAN) with the ability to attach many local computers.

Each local computer on the LAN gets its own “private” IP address, which are IPv4 addresses, but are only valid on the LAN. When a local computer needs to communicate with machines on the WAN (for example to “surf-the-net”), the network traffic bound for the WAN goes through the NAT box. The NAT box forwards all messages into the WAN using its public IP address, and when the responses come back to the NAT's public IP address, the NAT box forwards them on to the proper local computer using port mappings.

Port mappings allow NAT boxes to work. Accordingly, if A is attached to the Internet (WAN) only via a NAT box, whenever A wants to talk to machines on the WAN, it must go through the NAT box. The box has a WAN connection, which may be denoted as follows: A's NAT box's WAN IP address as NA. Generally, a designation of an IP address and a port, as used herein, is IPAddress:Port, e.g., A:X. When communications from A:X (with IP address (A) and port (X)) destined for the WAN arrive at the NAT box, the box sets up a proxy port Y on its WAN side for A:X, which is denoted as NA:Y. So communications going from A:X to B:J would flow A:X>NA:Y>B:J and B:J>NA:Y>A:X.

There are several ways for the NAT to enable the proxy ports. In particular, there are four different ways NAT boxes implement the mapping between A:X and its proxy port NA:Y, which are described below. These mappings are set up when communication is initiated from A:X to B:J via NA:Y. In a full-cone NAT box, NA:Y will handle communications between A:X and any other computer. Specifically, a computer C, knowing or guessing NA:Y would be able to communicate with A:X. In an address-restricted cone NAT box, NA:Y would only be valid for communications between A:X and B, but any port on B. Specifically, B could use NA:Y for communications using some other port Q allowing B:Q>NA:Y>A:X. However, the NAT would not forward communications sent to NA:Y from another computer C, unless A:X first sends communications to C.

In a port-restricted cone NAT box, NA:Y would only be valid for communications sent between A:X and B:J. The NAT would not forward communications sent from another port Q on B unless A:X first sends communications to B:Q. In a symmetric NAT box, the NAT allocates a different proxy port for each IP address and port with which A:X communicates. For example, if A:X subsequently communicates with B:Q, some other NAT proxy port would be used, such as Z. So, we would have A:X>NA:Y>B:J and then A:X>NA:Z>B:Q. In the first three cases, NA:Y will be used for all future communications sent out from A:X until the mapping is removed from the NAT's internal tables. The mappings are only removed after several minutes of inactivity on NA:Y.

Custom configuration or port forwarding should also be examined. If B is also behind an NAT, when A's NAT attempts to contact B, it must go though B's NAT, using IP address NB. When B's NAT receives the communication from A:X (via NA:Y) it would normally not know where to forward it. There may be several computers behind B's NAT, so the question arises: To which computer should B's NAT forward the incoming communication?

Most NAT boxes allow the ability to specify which computer behind the NAT should receive an inbound request on a specific port. For example, HTTP requests are usually received on port 80. B's NAT could be configured to forward any inbound requests on port 80 to computer D. Computer D would be running a web server listening on D:80. In this case, if port J is a fixed port number on which B is listening for new communications, that NAT could be configured to forward communications on NB:J to B:J. There are several limitations, including: (1) perhaps other computers also want to receive inbound communications on port J or port 80 (for example, there may be several computers behind an NAT that want to serve web pages to the Internet on port 80.); (2) Port J might not be a fixed port number; and (3) the user may not be capable of configuring the NAT to forward inbound requests to port J either because he lacks the technical ability or the administrative security access.

Referring now to Universal Plug & Play (UPnP), this is an emerging standard to support the ability to plug devices into a home network with an NAT box and then to allow the devices advertise and search for other devices of interest. This protocol is primarily directed at home networking, but there is some support in NAT boxes to allow devices to automatically configure forwarding of incoming requests. Still, this is a new protocol, which is not in wide use.

There are two primary security issues related to our Basic NAT Traversal Protocol, namely: (1) Authentication—allowing the peers and the control server to be certain that they know with whom they are talking; and (2) Privacy—ensuring that others cannot understand the communications sent between peers. Security attacks come in many forms and must be addressed.

Packet Sniffing—According to The On-line Hacker Jargon File, to sniff is “To watch packets traversing a network. Most often in the phrase packet sniffer, a program for doing same.” A packet sniffer can obtain passwords or other data, which can be used in a security attack or just to invade someone's privacy.

Spoofing—According to The On-line Hacker Jargon File, to spoof is “To capture, alter, and retransmit a communication stream in a way that misleads the recipient. As used by hackers, refers especially to altering TCP/IP packet source addresses or other packet-header data in order to masquerade as a trusted machine. This term has become very widespread and is borderline techspeak. Interestingly, it was already in use in its modem sense more than a century ago among Victorian telegraphers; it shows up in Kipling.”

Man-in-the-Middle Attacks—According to the Wikipedia, “a man in the middle attack (MITM) is an attack in which an attacker is able to read, and modify at will, messages between two parties without either party knowing that the link between them has been compromised. The attacker must be able to observe and intercept messages going between the two victims.” An MITM might use packet sniffing and spoofing to execute an attack.

Cryptography

Public Key—Using public-key cryptography, an entity B has a public key that everyone can know and a private key known only to B. Other entities can use B's public key to encrypt a message. Only B's private key (known only to B) can be used to decrypt such a message. Similarly, B can digitally sign a message by encrypting it using its private key. Everyone who knows B's public key is able to decrypt such a message and know it was signed by B. A message M that is encrypted with B's public key is denoted as {M}B_{pub}. A message M that is signed by B (by encrypting the message with it's private key) is denoted as {M} Bₚᵣᵢᵥ.

Symmetric (Secret) Key—Using symmetric key cryptography, entities A & B can use a key K to encrypt and decrypt messages sent between them. The same key is used for encryption and decryption, so the key must be a secret known only to A and B. A message M encrypted by a symmetric key K is denoted as {M}K. Using symmetric keys for encryption and decryption is much more efficient than using public-keys, but the challenge is secretly exchanging a symmetric key between A and B. Usually, this is done by having A choose the key, encrypting it with B's public key and sending it to B.

Message Digests—When receiving a message, it may be important to be able to verify that it has not been tampered with. Message digests (a.k.a. fingerprints or one-way hashes) are used to verify that the correct data was received, with very high probability. The digest is a small, fixed-size amount of data that is computed from the message. It is extremely unlikely that a transmission error would cause the message to be altered but still to have the same digest. Also, it is very hard for an attacker to substitute an alternate message that has the same digest. The natural attack would be to substitute an alternate message along with an alternate message digest. To guard again this attack, the sender sends the message and a digitally signed digest. Here, the message digest is digitally signed using the sender's private key. The receiver verifies that the message was not tampered with by re-computing the message digest and then seeing if it is the same as the digitally signed digest decrypted using the sender's public key.

Certificates—In order that an entity A can know with certainty B's public key, B sends (to A) its (B's) certificate which contains information about B including B's name, B's public key, and a digitally signed message digest. The digest will be signed by a certificate authority's (CA's) private key. The CA is a trusted third party whose public key is pre-installed into A (and we expect into B and all other entities using this application). Entity A uses the CA's public key to ensure that the certificate was not tampered with. This means that the CA has done some amount of work to ensure that B's name and B's public key are correct.

Certificate Signing Requests (CSRs)—The signing and distribution of certificates is very important and usually very complex in Internet name spaces such as the Domain Name Service used by the Worldwide Web. In the Worldwide Web, web browsers have pre-installed the public keys of trusted, third-party CAs (in the form of Trusted Root Certificates). Users can install additional Trusted Root Certificates. For an entity to get its certificate signed by a trusted, third-party CA, it provides to the CA a certificate signing request (CSR) and then it must prove its identity to the satisfaction of the CA. The CSR contains identifying information about the entity (e.g., its domain name such as www.xyz.com) as well as the entity's public key. After proving to the satisfaction of the CA its identity, the CA will use the information in the CSR to create a signed certificate, which it will give to the entity.

SSL—The Secure Socket Layer (SSL, standardized by the Internet Engineering Task Force (IETF) as the Transport Layer Security (TLS)) provides authentication and privacy automatically integrated into TCP connections. When an SSL connection is made from A to B, B provides its certificate to A. It is signed by a trusted CA whose public key is pre-installed into A (and B, etc). Then A generates a symmetric key (the session key), encrypts it with B's public key and sends it to B. This symmetric key is then used to encrypt all subsequent communications on this TCP connection (this session). In the current versions of SSL and TLS (SSLv3 and TLSv1) the server (B, the Receiver) has the option of requiring that the client (A, the Initiator) also authenticate by sending its certificate to the server. This way the server can know with certainty the identity of the client. Client authentication is not commonly used. Most applications authenticate clients by receiving a user id and password that are sent over the encrypted SSL connection after it is set up.

### SUMMARY OF THE INVENTION

It is, therefore, an object of the present invention to provide a method and system for establishing a direct connection between a first entity and a recipient peer. It is another object of the present invention to provide a method and system for establishing a direct connection between a first entity and a recipient peer, where inbound TCP connections to computers are attached to the Internet vian NAT boxes and without requiring the use of IPv6 or special NAT configuration, such as user-specified port mappings or support for Universal Plug-and-Play. It is a still further object of the present invention to provide a method and system for establishing a direct connection between a first entity and a recipient peer without passing all communication through intermediaries. It is yet another object of the present invention to provide a method and system for establishing a direct connection between a first entity and a recipient peer where one or both peers are behind an NAT box. It is a further object of the present invention to provide a method and system for establishing a direct connection between a first entity and a recipient peer that is portable from network to network and still be found anywhere on the Internet. It is a still further object of the present invention to provide a method and system for establishing a direct connection between a first entity and a recipient peer that is implementable with out-of-the-box NAT boxes. It is another object of the present invention to provide a method and system for establishing a direct connection between a first entity and a recipient peer that integrates security solutions for spoofing, authentication and privacy. It is a still further object of the present invention to provide a method and system for establishing an outbound TCP communication from a recipient peer that overcomes the deficiencies of the prior art. It is yet another object of the present invention to provide a method and system for securely registering at least one peer with a control server over a secure connection that overcomes the deficiencies of the prior art.

The present invention is directed to a computer-implemented Network Address Translation (NAT) traversal method for establishing a direct connection from a first entity, with at least one IP address and at least one port, to a second entity, including a recipient peer, with at least one IP address and at least one port and communicating through a recipient NAT box, with at least one IP address and at least one port. The method includes the steps of: (a) initiating an outbound TCP communication by the recipient peer through the recipient NAT box to the first entity; (b) creating, at the recipient NAT box, a mapping for use in forwarding requests between the at least one IP address and at least one port of recipient NAT box to the at least one IP address and at least one port of the recipient peer; (c) rejecting the communication by the first entity; (d) initiating a TCP communication by the first entity, at the at least one IP address and at least one port of the first entity, with the recipient peer, at the at least one IP address and at least one port of the recipient peer, through the recipient NAT box, at the at least one IP address and at least one port of the recipient NAT box utilizing the mapping, thereby establishing a direct communication between the first entity and the recipient peer.

The present invention is further directed to a computer-implemented method for establishing an outbound TCP communication from a recipient peer, with at least one IP address and at least one port. The method includes the steps of: (a) transmitting at least one identification request from the recipient peer over a User Datagram Protocol (UDP) communication to a control server, with at least one IP address and at least one port, the request including data sufficient for the control server to identify the recipient peer; and (b) transmitting a subsequent UDP communication from the control server to the recipient peer, when the control server requires the recipient peer to effect an outbound TCP communication.

In addition, the present invention is directed to a method of securely registering at least one peer, having at least one IP address and at least port, with at least one control server, having at least one IP address and at least one port. The method comprising the steps of: transmitting, by the at least one peer, a setup request to the at least one control server via a secure connection; and maintaining, by the control server, and for the at least one peer, a peer record, including: (i) peer identification data; (ii) an IP address of the peer sending the setup request; (iii) a time stamp indicating when the last message was received for the peer; (iv) an indication of whether the peer has securely registered; (v) the remote port from which a subsequent insecure communication is initiated, or any combination thereof; and transmitting, by the control server, a reply to the peer via a secure connection, the reply including at least a portion of the peer identification data; and establishing, by the peer, a port to use for the transmission of subsequent insecure communications.

These and other features and characteristics of the present invention, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and the claims, the singular form of “a”, “an”, and “the” include plural referents unless the context clearly dictates otherwise.

### BRIEF DESCRIPTION OF THE DRAWINGS

FIG. 1 is a flow diagram of one embodiment of a Network Address Translation (NAT) protocol for Transmission Control Protocol (TCP) transmissions according to the present invention;

FIG. 2 is a flow diagram of a further embodiment of a Network Address Translation (NAT) protocol for Transmission Control Protocol (TCP) transmissions according to the present invention;

FIG. 3 is a flow diagram of another embodiment of a Network Address Translation (NAT) protocol for Transmission Control Protocol (TCP) transmissions according to the present invention;

FIG. 4 is a flow diagram of a further embodiment of a Network Address Translation (NAT) protocol for Transmission Control Protocol (TCP) transmissions according to the present invention;

FIG. 5 is a flow diagram of a still further embodiment of a Network Address Translation (NAT) protocol for Transmission Control Protocol (TCP) transmissions according to the present invention; and

FIG. 6 is a flow diagram of another embodiment of a Network Address Translation (NAT) protocol for Transmission Control Protocol (TCP) transmissions according to the present invention.

### DETAILED DESCRIPTION OF THE PREFERRED EMBODIMENTS

The present invention is a method for NAT Traversal for TCP Connections and provides a mechanism to create direct TCP connections between applications, whether or not they are behind NATs. In addition, the present invention provides a unique method for establishing an outbound TCP communication from a recipient peer. Still further, the present invention is directed to a method of securely registering at least one, and typically multiple, peers with a control server for use in subsequent insecure communication. The TCP connections do not route through intermediary servers, although one or more control servers that are not behind an NAT may be used during connection setup. The present invention works when the applications (or peers) are both behind different NAT boxes, such as when the recipient peer is behind a full-cone, address-restricted cone, or port-restricted cone NAT.

The present invention includes at least three distinct entities, namely: (1) the recipient peer, which is referred to as Peer_{B} herein, and which may be communicating through the recipient NAT box, which is referred to as NAT_{B} herein; (2) the initiating entity, initiator or first entity, which is referred to as Peer_{A} herein, and which may be communicating through an NAT box, which is referred to as NAT_{A}; and (3) a control server, which may include a single control server or multiple control servers in a networked and communicating relationship. In addition, it is to be understood that the invention may assume various alternative variations and step sequences, except where expressly specified to the contrary. It is also to be understood that the specific devices and processes illustrated in the attached drawings, and described in the following specification, are simply exemplary embodiments of the invention.

In one preferred and non-limiting embodiment of the present invention, the method for establishing a direct connection from a first entity to a second entity is implemented as follows: Peer_{A} (the Initiator) wants to set up a TCP connection to Peer_{B} (the Receiver). To set up this communication, the following issues must be addressed:

1. Peer_{A} needs to know what IP address and port to use to communicate with Peer_{B}.

2. Peer_{B} may be a mobile computer and may not have a fixed IP address.

3. Peer_{B} may be behind an NAT, so Peer_{A} must communicate with the Peer_{B}'s NAT (NAT_{B}) which must know to forward the communications on to Peer_{B} (as opposed to some other computer behind NAT_{B}).

Security issues must also be addressed, specifically: (i) providing authentication; and (iii) privacy, despite the ability of attackers to packet sniff, spoof or be an MITM.

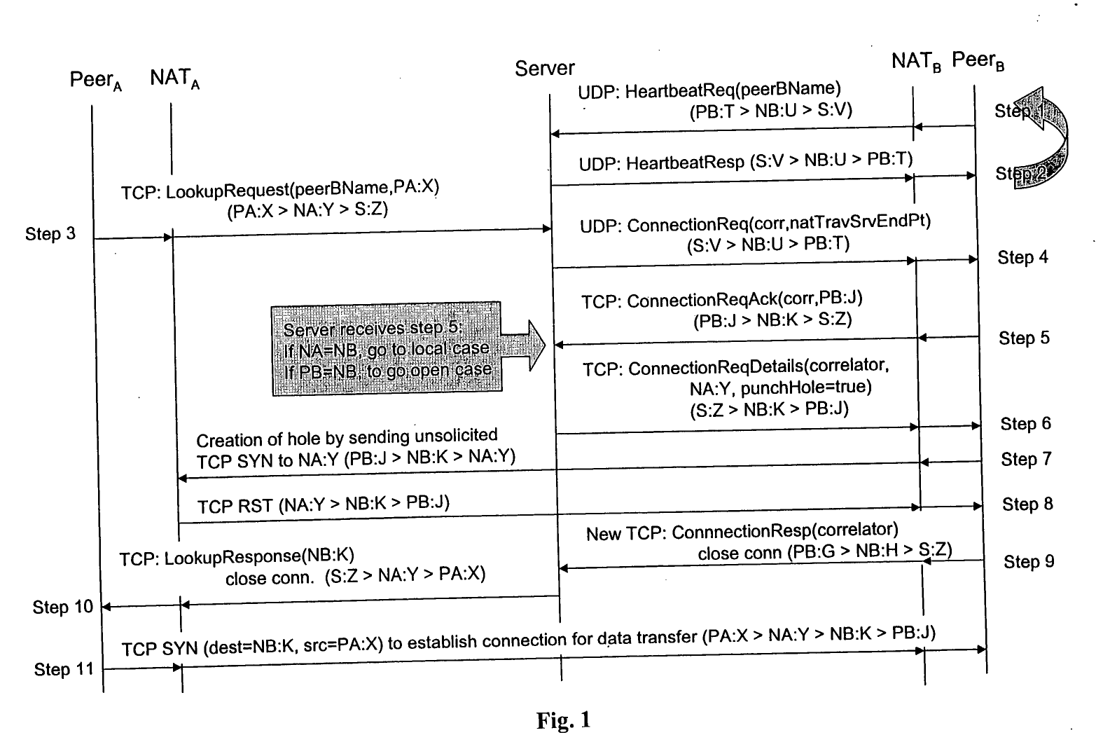

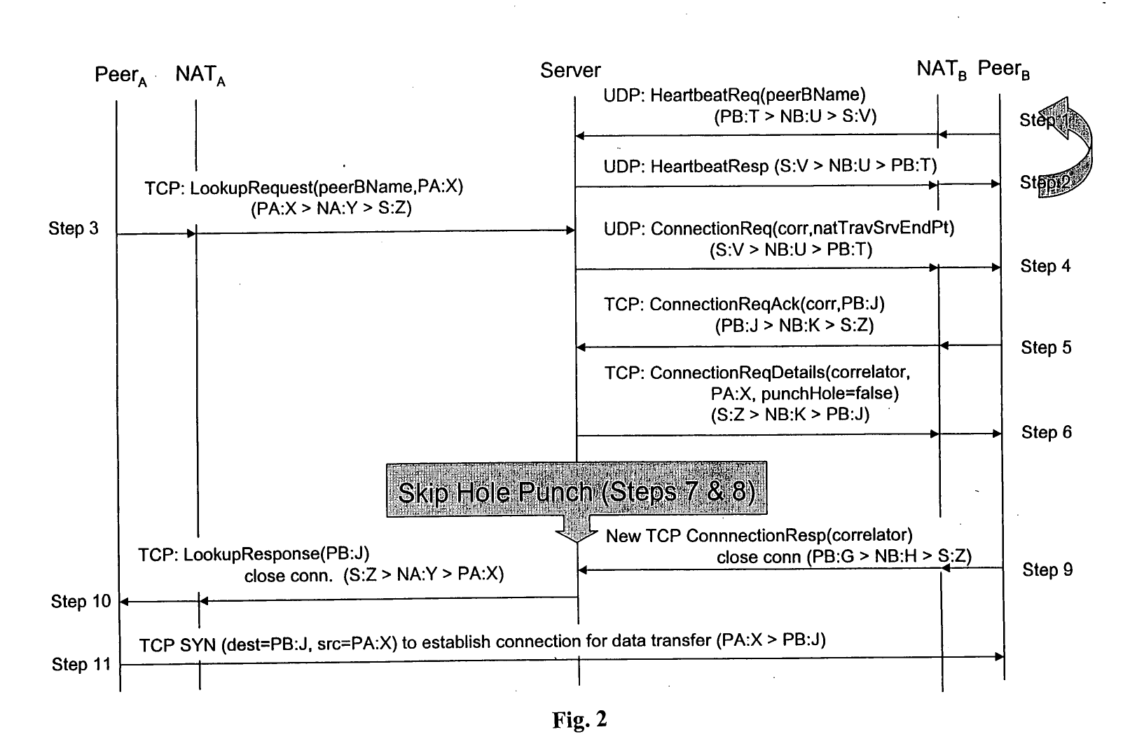

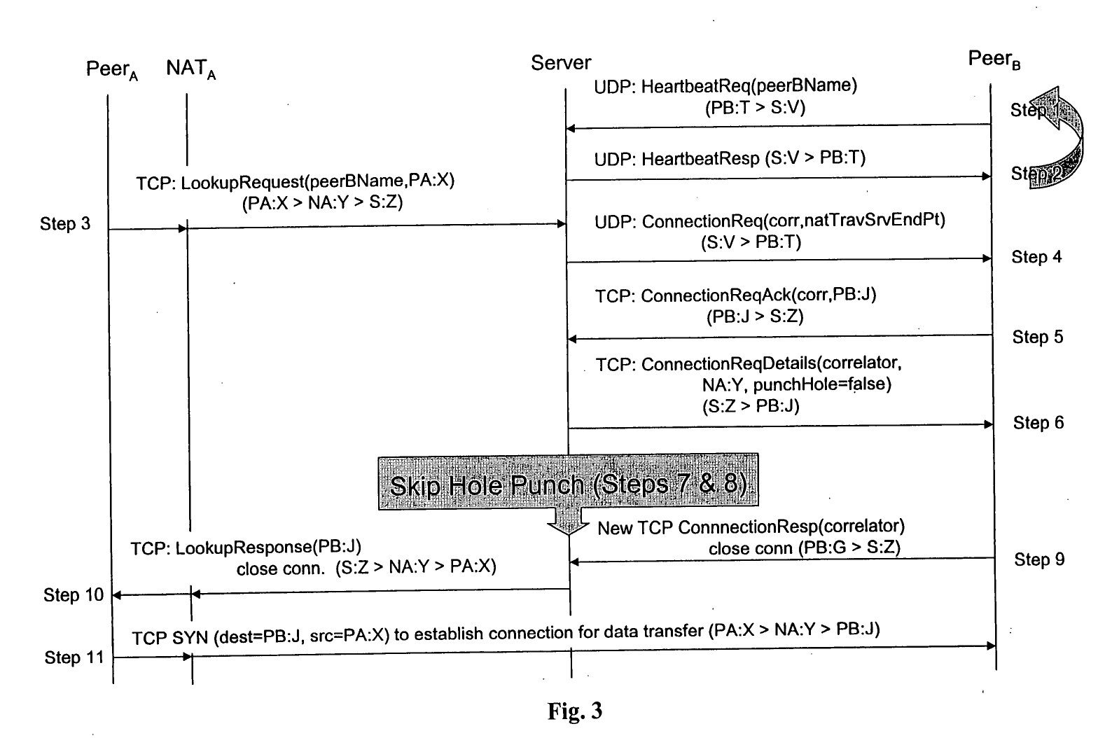

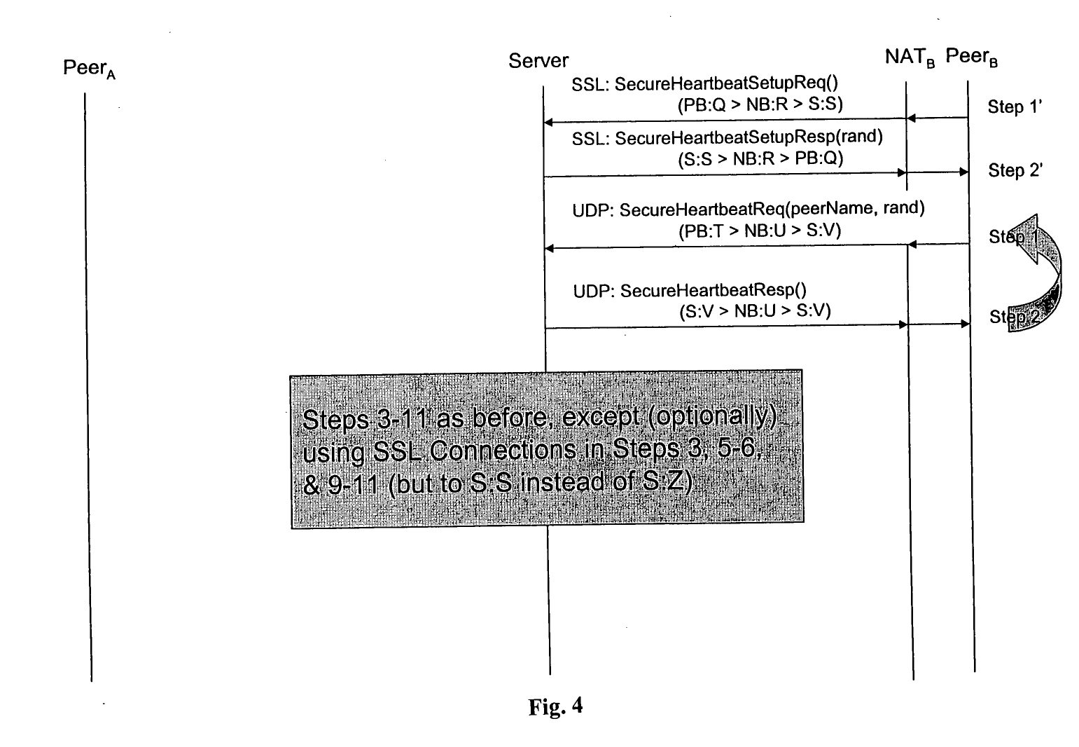

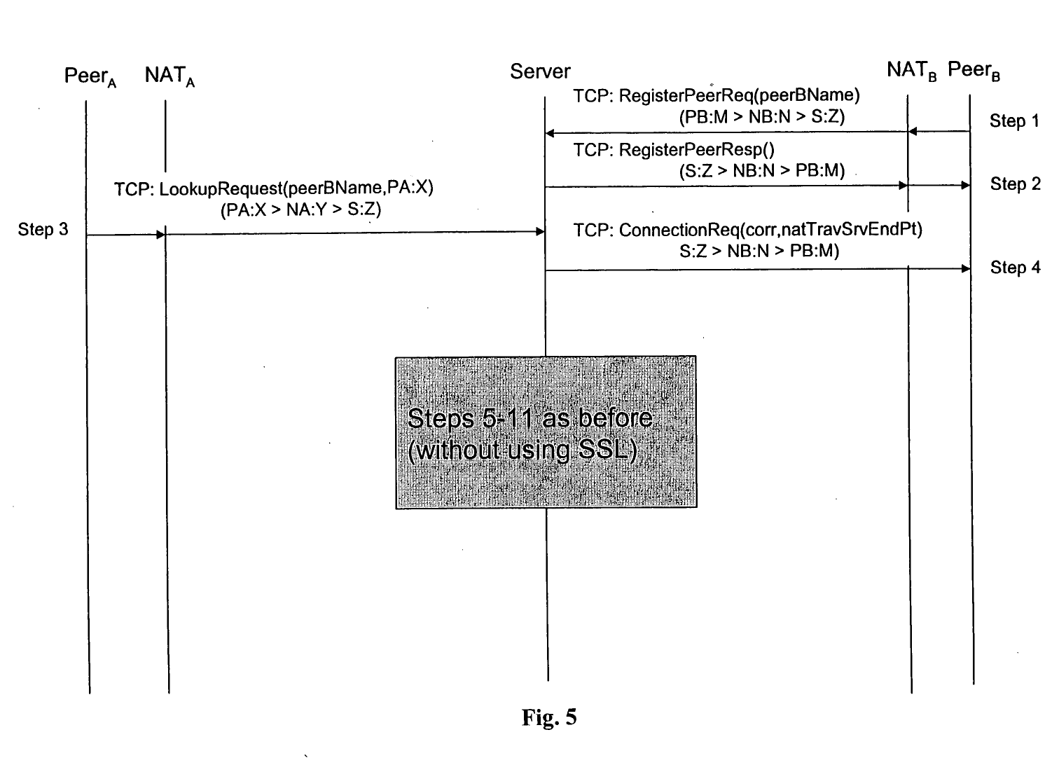

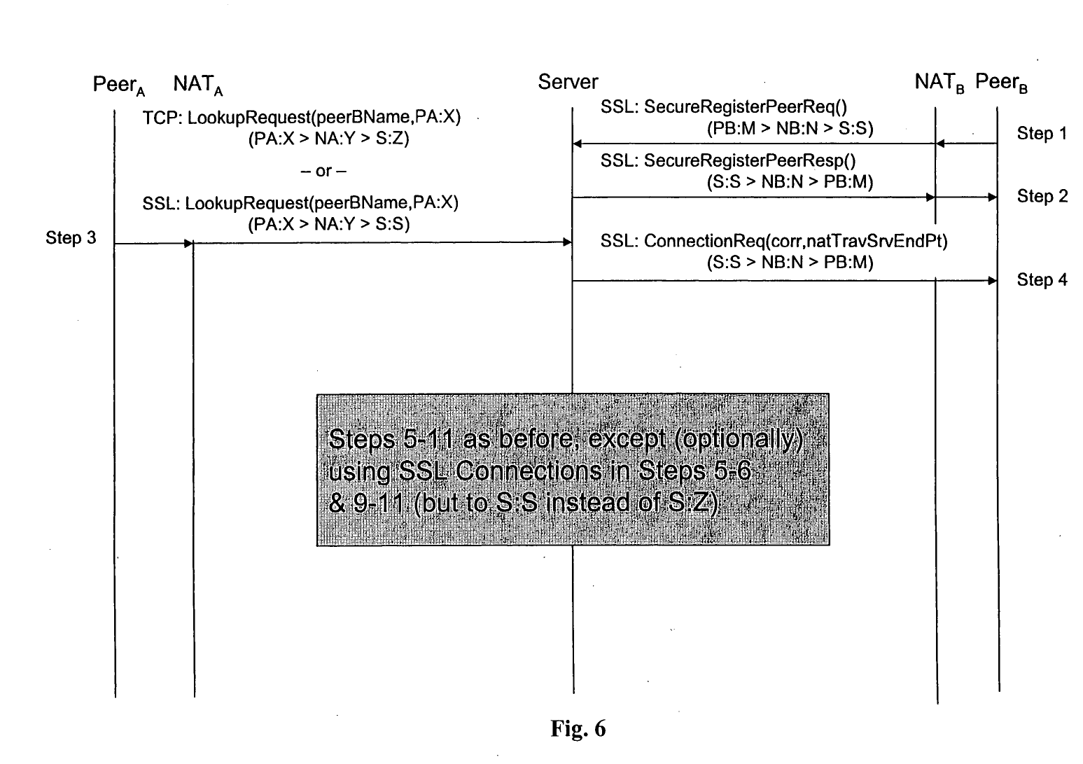

One preferred and non-limiting embodiment of the present invention is depicted in FIG. 1. Extensions to handle the Local Case (both peers behind the same NAT) and the Open Case (the recipient peer not behind an NAT) are depicted in FIGS. 2 and 3. FIG. 4 illustrates Security Extensions to provide authentication and privacy. FIGS. 5 and 6 illustrate protocol variations that do not use UDP for heartbeating (as discussed hereinafter), but, instead use TCP communications to register the peer, such as Peer_{B}. The computers involved are Peer_{A} (the Initiator) which wants to make a connection to Peer_{B} (the Receiver or Recipient). The present invention utilizes an intermediary control server (the Server) to facilitate making the direct connection between the peers. There can be multiple control servers for scalability and availability.

In one preferred and non-limiting embodiment, and with reference to FIG. 1, the present invention and method include the following steps:

Steps 1 & 2: Heartbeating

[symbol] As shown in FIG. 1, when Peer_{B} comes up, it starts sending HeartbeatRequest messages to the control server (Step 1) containing the symbolic name. These messages are sent via UDP, as that allows a larger number of Receivers to heartbeat with each control server, but TCP connections could be used if necessary for Steps 1, 2, and 4 (as illustrated in FIG. 5). For example, some firewall and router configurations may disallow the use of UDP messages.

[symbol] The server replies via UDP with a HeartbeatResponse message (Step 2). Functionally, the sending of this reply is optional but it facilitates failure detection if the control server is down. By not receiving any replies, the Receiver assumes the control server it is using is down and it attempts to find another control server to use. Round-robin DNS is a reasonable choice to distribute the heartbeating function across control servers.

By periodically sending HeartbeatRequest messages, Peer_{B}'s NAT (NAT_{B}) will maintain a mapping allowing the control server to send UDP requests to Peer_{B} at a future time. The UDP requests the control server will send are ConnectionRequests, which will be used to perform the necessary steps to set up a direct TCP connection between Initiators and this Peer_{B}. The frequency with which Peer_{B} needs to heartbeat to the control server is configurable and depends on the NAT boxes. An examination of the default values of many NAT boxes indicates that most NAT boxes will maintain UDP mappings for several minutes, so HeartbeatRequests are sent every minute. If Peer_{B} does not receive a timely HeartbeatReply, Peer_{B} actively resends the HeartbeatRequests every few seconds. If, after sending several HeartbeatRequests, Peer_{B} does not receive a HeartbeatReply, Peer_{B} reinitializes its network connection to the control server which addresses the case where Peer_{B} changes networks and/or the control server is down (causing a new one to be tried).

Specifically, Peer_{B} sends its HeartbeatRequest messages (Step 1) to the control server on its IP address and port (S:V). The IP address S can be configured or looked up in DNS. The port V is a fixed configuration parameter. Peer_{B} sends out the Heartbeat messages on its private (behind the NAT) IP address and port denoted as PB:T, the control server will see the message as coming from the NAT's public WAN IP address and port denoted as NB:U. The Server will be able to send HeartbeatResponses (Step 2) and ConnectionRequests (Step 4) from S:V to NB:U and NAT_{B} will forward them on to PB:T.

Step 3: LookupRequest When an Initiator (Peer_{A}) wants to set up a connection to some Receiver (Peer_{B}), it opens a TCP connection to the control server and sends a LookupRequest (Step 3) containing the symbolic name of Peer_{B} and its private (behind the NAT) IP address and port denoted as PA:X. Peer_{A} opens the TCP connection to the control server on its IP address (S) and a configurable port Z. The control server sees the LookupRequest as coming from NAT_{A}'s IP address and port denoted as NA:Y. The control server will reply on this TCP connection in Step 10 with a LookupResponse that provides the details necessary for Peer_{A} to ultimately create the direction connection to Peer_{B}. Should there be no Peer_{B} actively heartbeating with the control server, the control server returns a LookupError message on the TCP connection describing the error.

Step 4: ConnectionRequest After receiving a LookupRequest for Peer_{B}, the control server sends a ConnectionRequest message to Peer_{B} from S:V to NB:U which NAT_{B} forwards to PB:T. The control server awaits a ConnectionRequestAck (Step 5). If it does not receive it in a timely fashion, it will resend the ConnectionRequest. If, after sending the ConnectionRequest several times no ConnectionRequestAck was received, a LookupError is returned to Peer_{A}.

The ConnectionRequest contains a Correlator (corr) consisting of a serial number and a random number. The Correlator is then used in the ConnectionRequestAck and ConnectionResponse messages sent from Peer_{B} to the control server allowing the control server to determine on behalf of which LookupRequest these messages were sent. The ConnectionRequest also contains the IP address and port (natTravServerEndPt) of the control server that Peer_{B} should use for setting up the TCP connections in Steps 5 and 9. In the figures, this is depicted as S:Z, but this protocol supports replication of the control servers for scalability and availability. The control server used for Steps 5-10 must be the one to which Peer_{A} sent its LookupRequest. If this is not the same control server with which Peer_{B} has been heartbeating, Peer_{A}'s control server can contact Peer_{B}'s control server to tell it to send the ConnectionRequest to Peer_{B}. In this case, the natTravServerEndPt would be Peer_{A}'s control server's IP address and port.

Step 5: ConnectionRequestAck When Peer_{B} receives a ConnectionRequest, it checks the Correlator to see if it has received a duplicate ConnectionRequest. If it is a new ConnectionRequest, Peer_{B} opens a TCP connection to the control server specified in the ConnectionRequest and sends it an acknowledgement, ConnectionRequestAck. The ConnectionRequestAck contains the Correlator (corr) and Peer_{B}'s private IP address and port for the TCP connection (PB:J). The control server sees the ConnectionRequestAck as coming from NAT_{B}'s public IP address and port (NB:K). If the Correlator is not in use, is to be used by a different recipient peer, or the ConnectionRequestAck was already received, an message, InvalidConnectionError, is sent back to Peer_{B}.

Step 6: ConnectionRequestDetails When receiving the ConnectionRequestAck, the control server compares NB with NA and PB.

FIG. 1: The Typical Case—If NB is not equal to NA or PB, the method will proceed as usual in FIG. 1. The control server sends a ConnectionRequestDetails message back to Peer_{B} on the TCP connection. This message tells Peer_{B} that the connection from Peer_{A} will be coming through NAT_{A} on IP address and port NA:Y and that it will be necessary for Peer_{B} to punch a hole in NAT_{B} so that the TCP connection will go through to Peer_{B} (punchHole=true).

FIG. 2: The Local Case—If NB and NA are equal, the control server concludes that Peer_{B} and Peer_{A} are behind the same NAT. In this case, the method sends a ConnectionRequestDetails message telling Peer_{B} that the connection from Peer_{A} will be coming to it from Peer_{A}'s private IP address and port PA:X and that it does not need to punch a hole in NAT_{B} (punchHole=false).

FIG. 3: The Open Case—If NB and PB are equal, the control server concludes that Peer_{B} is not behind an NAT. In this case, a ConnectionRequestDetails message is sent telling Peer_{B} that the connection from Peer_{A} will be coming to it from NAT_{A}'s public IP address and port NA:Y but that it does not need to punch a hole in NAT_{B} (punchHole=false) as there is no NAT_{B}. Note: In the case that Peer_{A} is not behind an NAT, PA:X is equal to NA:Y and everything above and below works the same.

In any case, after receiving the ConnectionRequestDetails, Peer_{B} closes the TCP connection to the control server. If punchHole=true, it executes Steps 7 & 8 to punch a hole in NAT_{B}. If punchHole=false, Peer_{B} skips Steps 7 and 8, sets up for Step 11, and then executes Step 9. At this point, the control server awaits a new TCP connection, upon which it will receive a ConnectionResponse message from Peer_{B}. If this does not happen in a timely fashion, the control server will return a LookupError to Peer_{A}.

Steps 7 & 8: Punching the Hole in NAT_{B}

To punch the hole, Peer_{B} reuses the IP address and port it used for the TCP connection in Steps 5 & 6 (PB:J) and attempts to set up a TCP connection to Peer_{A} using the IP address and port provided in the ConnectionRequestDetails message (NA:Y). This connection will be set up using the same NAT_{B} public WAN IP address and port used in Steps 5 & 6 (NB:K). In Step 7, Peer_{B} sends the first part of the TCP 3-step handshake to Peer_{A}. This is called a TCP SYN packet.

If NAT_{A} is an address-restricted cone or port-restricted cone NAT, the attempt to set up the connection from Peer_{B} to Peer_{A} through NAT_{B} is blocked by NAT_{A}. In Step 8, NAT_{A} returns an IP message called a TCP RST to indicate that the connection was not made. If NAT_{A} is a full-cone NAT, it will forward the TCP SYN to PA:X. If Peer_{A} is not behind an NAT, NA:Y equals PA:X and the TCP SYN will do directly to Peer_{A}. In either case, the connection request will be rejected by Peer_{A} because PA:X is already in use, connected to S:Z.

Even though the connection from Peer_{B} to Peer_{A} was blocked by NAT_{A} or rejected by Peer_{A}, NAT_{B} now contains a mapping which will forward subsequent requests received on NB:K (and if an address-restricted cone NAT sent from NA, and if a port-restricted cone NAT sent from NA:Y). These requests received on NB:K will now be forwarded to PB:J.

Set up for Step 11: Listen for the Connection from Peer_{A} Before sending the ConnectionResponse in Step 9, the method sets up to listen for the connection from Peer_{A} in Step 11. This connection must come in on PB:J, so a server socket is set up to listen on PB:J.

Step 9: ConnectionResponse Peer_{B} opens a new TCP connection to the control server. It cannot use port J for this connection. Call this new port G. The ConnectionResponse contains the Correlator (corr) and indicates that Peer_{B} is ready to receive the direct connection from Peer_{A}. (The control server receives this message from NAT_{B}'s IP address and port denoted as NB:H.) This TCP connection is then closed.

Step 10: LookupResponse After the control server receives the ConnectionResponse from Peer_{B}, it uses the Correlator to determine on behalf of which LookupRequest the ConnectionResponse was sent. The control server sends a LookupResponse message back to Peer_{A} on the TCP connection that was used in Step 3. This TCP connection is then closed. If the Correlator is not in use, the ConnectionResponse is ignored. The LookupResponse contains the IP address and port that Peer_{A} should use to make a direct connection to Peer_{B}. This will be NB:K in the Usual Case or PB:J in the Local or Open Cases.

Step 11: The Connection from Peer_{A} to Peer_{B} After it receives the LookupResponse, Peer_{A} can now make the direct connection to Peer_{B} using the IP address and port provided in the LookupResponse. The connection must be made from PA:X. If the connection needs to go through NAT_{B}, it can because a hole will have been punched in Steps 7 & 8. If the connection goes through NAT_{A}, it will appear to Peer_{B} as if the connection comes from NA:Y otherwise it will appear as if it is coming from PA:X.

In implementing the basic NAT Traversal Protocol of the present invention, a rogue peer can usurp connections that should go to Peer_{B} by simply sending to the control server HeartbeatRequest messages containing Peer_{B}'s name. A rogue server can pretend to be a control server by spoofing and then can usurp any or all of the new connections. Packet sniffers can eavesdrop on communications between the peers to obtain passwords or other private data. A Man-in-the-Middle can commandeer the direct connection legitimately made between two peers.

These sorts of attacks are commonly prevented using public-key cryptography and the Secure Socket Layer (SSL) or Transport Layer Security (TLS) to provide authentication and privacy. These are the same techniques used to protect the Worldwide Web (i.e., https). In one preferred embodiment, the present invention utilized SSL methodology to protect the TCP communications. This SSL methodology may also be used to securely register Peer_{B} before starting the UDP Heartbeating.

Signed Certificate Distribution—In order to use SSL and public key cryptography, certificates must be created and signed by a trusted third party. The present invention may utilize such application specific mechanisms to securely provide signed certificates to the peers.

Protecting TCP Connections—MITM attacks are obviated by setting up a direct SSL (or TLS) connection between the peers (Step 11). Even after Steps 1-10 execute without interference, an MITM can jump in at Step 11 and grab that direct TCP connection. Authentication provided by SSL as described above ensures that the peers at each end are who they claim. Privacy means that only the peers at each end will understand the communication. Should the MITM or a packet sniffer eavesdrop, he will not understand the communication. Should the MITM attempt to re-route the connection to another party, he would not be able to authenticate at set-up nor would he understand the encrypted communication afterwards.

Using SSL is optional, but recommended for the TCP connections setup in Steps 3, 5, and 9. Doing so certainly makes it more difficult for an MITM to pretend to be a rogue server or a rogue peer and mischievously redirect a connection to a wrong computer. But in the end an MITM can always get into the action when the final TCP connection in Step 11 in set up. Ultimately, SSL should be used in Step 11 to protect against MITM attacks.

Protecting UDP—The UDP connections in the NAT Traversal Protocol (FIGS. 1-3) require special attention as in the Basic NAT Traversal Protocol, a rogue peer can claim to be Peer_{B} by simply sending (to the control server) HeartbeatRequest messages containing Peer_{B}'s name. Such a rogue does not even need to be an MITM. To guard against these attacks, in one embodiment, Peer_{B} registers with the control server using an SSL connection (Steps 1′ & 2′ in FIG. 4). The IP addresses and ports are the same as in the basic protocol as depicted in FIGS. 1, 2, and 3, except the control server uses a different port to receive SSL connections, denoted as (S:S).

Step 1′: SecureHeartbeatSetupRequest—To securely register with the control server, Peer_{B} sends a SecureHeartbeatSetupRequest message via SSL to the control server. The control server maintains PeerRecords for each active peer. Each PeerRecord contains the peer's name, a control server generated random number, the IP address from which the SecureHeartbeatSetupRequest message was sent (PB or NB depending on the cases as per FIGS. 1-3), and a timestamp indicating when the last message was received for this peer. Also contained in the PeerRecord is a boolean value that is true to indicate that Peer_{B} has securely registered and the remote port from which heartbeat messages are being sent (the port is filled in during Step 1, below). The same record is kept for the basic protocol except that the boolean value is false and the random number field is not used.

When the control server receives the SecureHeartbeatSetupRequest it creates a new PeerRecord setting the boolean to true indicating secure registration, records Peer_{B}'s name and IP address, initializes the timestamp, and generates a new random number that it stores in the PeerRecord.

Step 2′: SecureHeartbeatSetupResponse—The control server replies over the SSL connection with a SecureHeartbeatSetupResponse message containing the random number. Upon receiving the SecureHeartbeatSetupResponse, Peer_{B} creates a UDP port which it uses for heartbeating, denoted as (PB:T) as in the Basic Protocol.

Step 1: SecureHeartbeatRequest—Peer_{B} now sends a SecureHeartbeatRequest message to the control server containing Peer_{B}'s name and the random number. When receiving the SecureHeartbeatRequest, the control server uses the peer name to lookup its record for Peer_{B}. The control server checks the IP Address from which the SecureHeartbeatRequest was sent (PB or NB depending on the case) and the random number in the SecureHeartbeatRequest to ensure that they match the corresponding values in the PeerRecord. If they do not or if there is no PeerRecord for this name, the control server sends back a HeartbeatSecurityExceptionResponse causing Peer_{B} to re-iniate heartbeating with Step 1′ (SecureHeartbeatSetupRequest). Otherwise, the control server updates the timestamp and fills in the port in the PeerRecord and sends back a SecureHeartbeatResponse (Step 2).

Step 2: SecureHeartbeatResponse—If the control server responds with a SecureHeartbeatResponse, it means that the heartbeat was successfully processed. The message contains no parameters, but allows Peer_{B} to know that there were no failures in the secure heartbeating protocol. Peer_{B} continues to heartbeat using the retry and re-initialization techniques as described in the Basic Protocol. It processes ConnectionRequest messages as in the Basic Protocol, except that SSL connections are (recommended to be) used in Steps 3, 5, 6, 9, 10, and 1 1 to ensure the identities of the peers and the control servers.

Various types of attacks on the NAT Traversal Protocol of the present invention (using the above Security Extensions) are as follows:

Rogue Peer—A rogue peer claiming to be Peer_{B} can no longer succeed. It will not be able to set up the SSL connection in order to send the SecureHeartbeatSetupRequest. If the rogue peer attempts to send a SecureHeartbeatRequest message it will not be able to send it with the right random number and will not be able to use the correct IP address and port. It will receive a HeartbeatSecurityExceptionResponse.

Replay of SecureHeartbeatRequest Message—If a Man-in-the-Middle (MITM) replays a SecureHeartbeatRequest message, the control server will examine the random number and the IP address and port from which it was sent. If the control server can find the PeerRecord for Peer_{B} in its table, it will verify that the correct random number, IP address and port are being used. If so, it will consider Peer_{B} to still be alive on this IP address and port. Should a subsequent LookupRequest (Step 3) arrive at the control server, the control server will send a ConnectionRequest (Step 4) to this IP address and port. At this point, the MITM could attempt to respond with a ConnectionRequestAck (Step 5), but if SSL is being used (recommended) it will not be able to set up the SSL connection. If SSL is not being used until Step 11 (strongly recommended), the hole will be punched and Peer_{A} will be directed to connect to Peer_{B} but the MITM will not be able to setup the SSL connection with Peer_{A}.

Once Peer_{B} starts communicating with the control server from a new location, a new PeerRecord will replace the old PeerRecord in the control server. The new PeerRecord will contain a new random number and a new IP address and port. After this point replay of the old SecureHeartbeatRequest messages will return HeartbeatSecurityExceptionResponses as described above. So the only problem an MITM can cause (in addition to simply blocking communication) is to make the control server believe that Peer_{B} is still running at an old location until Peer_{B} starts up again in a new location. By using SSL in Steps 5, 6, 9, 10, and 11 there is no possibility that an MITM can successfully direct connections to the wrong peers.

Modification of the ConnectionRequest Message—If an MITM modifies the natTravSrvEndPt parameter to cause Peer_{B} to send the subsequent ConnectionRequestAck to the wrong control server, Peer_{B} will likely get an InvalidCorrelatorExceptionResponse due to the invalid Correlator or due to SSL authentication issues. If the MITM sets the natTravSrvEndPt to a rogue control server, Peer_{B} will not be able to set up the SSL connection for Step 5.

The MITM could modify the ConnectionRequest to contain a previously valid Correlator sent for Peer_{B}. If this Correlator corresponds to a ConnectionRequest that is currently being processed, Peer_{B} will consider this to be a duplicate UDP message and ignore it. If the Correlator is for an older request that Peer_{B} is no longer working on, it will sent another ConnectionRequestAck message to the control server using SSL. At this point the control server will detect that this is an inactive Correlator or a Correlator for which it has already received a ConnectionRequestAck and it will return an InvalidCorrelatorExceptionResponse.

In summary, these security extensions provide authentication and privacy of communication between peers. Specifically the security extensions: (i) ensure that a rogue peer who is not a Man-in-the-Middle cannot successfully pretend to be a good peer, (ii) ensure that a Man-in-the-Middle (or packet sniffer) cannot obtain information he could later use to pretend to be a good peer, and (iii) ensure that if a Man-in-the-Middle allows communications between the peers, it will cause no harm. At worst, an MITM can only deny communication between peers.

With respect to scalability, the present invention may use UDP for heartbeating because it allows the control server to service a much larger number of peers (Steps 1 & 2 in FIGS. 1-4). However, some implementations may choose instead to use TCP connections for maintaining a control connection between the control server and each peer. If so, Peer_{B} would initiate a TCP connection to the control server that would be used in Steps 1, 2, and 4 as shown in FIG. 5. The secure version of the protocol without UDP is shown in FIG. 6. Here the client uses an SSL connection to maintain its control connection with the control server. Using UDP heartbeating, each control server will be able to support a much greater number of peers, but for some environments that do not allow UDP, the TCP-only versions of the protocol could support a limited number of peers.

The present invention provides a method for NAT traversal for TCP connections, which provides a mechanism to create TCP connections between peers running P2P applications even when the peers are both behind different NATs. In addition, the present invention provides a method and system for establishing an outbound TCP communication from a recipient peer. Still further, the present invention provides a method of registering at least one peer with at least one control server. Among the features of the present invention and its embodiment:

Direct Connections—The TCP connections do not route through intermediary servers, although one or more computers that are not behind NATs are used during connection setup.

Mobility—Integrated name service allows peers to move around to different IP addresses throughout the Internet and still be found.

Security—Integrated security provides
(i) spoofing prevention—rogue peers (non-middlemen) on the network cannot register as some other peer thereby usurping connections intended to go to the other peer;
(ii) authentication—each peer can automatically confirm identity of the other peer with which they are connected; and
(iii) privacy—the contents of the communication cannot be understood by others eavesdropping or forwarding content on the network.

Local Case Optimization—When both peers are behind the same NAT, a direct connection is made without going through the NAT. The hole punching protocol is not performed.

Open Case Optimization—When the Receiver peer (Peer B) is open (not NATed), hole punching protocol is not performed.

Works with Popular NATs—Our invention works with the types of NATs most commonly in use: full-cone, address-restricted cone, and port-restricted cone NATs.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

We claim:

1. A computer-implemented Network Address Translation (NAT) traversal method for establishing a direct connection from a first entity, with at least one Internet Protocol (IP) address and at least one port, to a second entity, including a recipient peer, with at least one IP address and at least one port and communicating through a recipient NAT box, with at least one IP address and at least one port, the method comprising the steps of:
(a) initiating an outbound Transmission Control Protocol (TCP) communication by the recipient peer through the recipient NAT box to the first entity;
(b) creating, at the recipient NAT box, a mapping for use in forwarding requests between the at least one IP address and at least one port of recipient NAT box to the at least one IP address and at least one port of the recipient peer;
(c) rejecting the communication by the first entity; and
(d) initiating a TCP communication by the first entity, at the at least one IP address and at least one port of the first entity, with the recipient peer, at the at least one IP address and at least one port of the recipient peer, through the recipient NAT box, at the at least one IP address and at least one port of the recipient NAT box utilizing the mapping, thereby establishing a direct communication between the first entity and the recipient peer.

2. The method of claim 1, wherein the first entity is an initiator peer, an initiator NAT box or any combination thereof.

3. The method of claim 1, wherein, prior to step (a), the method further comprises the steps of:
transmitting a lookup request by the first entity to at least one control server, with an IP address and at least one port;
transmitting a connection request by the control server to the recipient peer through the recipient NAT box;
transmitting an acknowledgement from the at least one IP address and at least one port of the recipient peer to the control server through the at least one IP address and at least one port of the recipient NAT box; and
transmitting a connection confirmation from a control server to the recipient peer through the recipient NAT box, the confirmation including the at least one IP address and port of the first entity; and
wherein, after step (c) and prior to step (d), the method further comprises the steps of:
transmitting a connection response from the recipient peer to the control server; and
transmitting a lookup response message from a control server to the first entity, the response message including the at least one IP address and at least one port of the recipient NAT box.

4. The method of claim 3, wherein at least one transmission between the control server and the recipient peer includes: (i) correlator data for determining the identity of the recipient peer; (ii) the at least one IP address and port of the control server; (iii) the at least one IP address and port of the control server to which the lookup request was transmitted, or any combination thereof.

5. The method of claim 3, wherein at least one communication, connection or transmission of data is effected over a secure communication using public-key encryption methodology, Secure Socket Layer (SSL) methodology, Transport Layer Security (TLS) methodology or any combination thereof.

6. The method of claim 3, wherein there is a plurality of discrete control servers in communication with each other, the method further comprising the step of: communicating data between the plurality of servers, the data including: first entity data, recipient peer data, IP address data, port data, NAT box data, initiator data, recipient data, responder data, correlator data, control server data, connection data, message data, action data, communication data, connectivity data, socket data, or any combination thereof.

7. The method of claim 1, wherein, prior to step (a), the method further comprises the steps of:
transmitting a lookup request by the first entity peer to at least one control server, with at least one IP address and at least one port;
transmitting a connection request by a control server to the recipient peer through the recipient NAT box, the request including the at least one IP address and port of the first entity;
transmitting an acknowledgement from the at least one IP address and at least one port of the recipient peer to the control server through the at least one IP address and at least one port of the recipient NAT box; and
transmitting a connection confirmation from a control server to the recipient peer through the recipient NAT box; and
wherein, after step (c) and prior to step (d), the method further comprises the steps of:
transmitting a connection response from the recipient peer to the control server; and
transmitting a lookup response message from a control server to the first entity, the response message including the at least one IP address and port of the recipient NAT box.

8. The method of claim 7, wherein at least one transmission between the control server and the recipient peer includes: (i) correlator data for determining the identity of the recipient peer; (ii) the at least one IP address and port of the control server; (iii) the at least one IP address and port of the control server to which the lookup request was transmitted, or any combination thereof.

9. The method of claim 7, wherein at least one communication, connection or transmission of data is effected over a secure communication using public-key encryption methodology, Secure Socket Layer (SSL) methodology, Transport Layer Security (TLS) methodology or any combination thereof.

10. The method of claim 7, wherein there is a plurality of discrete control servers in communication with each other, the method further comprising the step of: communicating data between the plurality of servers, the data including: first entity data, recipient peer data, IP address data, port data, NAT box data, initiator data, recipient data, responder data, correlator data, control server data, connection data, message data, action data, communication data, connectivity data, socket data or any combination thereof.

11. The method of claim 1, wherein, prior to step (a), the method further comprises the steps of:
(a1) periodically transmitting at least one identification request from the recipient peer over a User Datagram Protocol (UDP) communication to a control server, with at least one IP address and at least one port, through the recipient NAT box, the request including data sufficient for the control server to identify the recipient peer; and
(a2) establishing a mapping on the recipient NAT box for transmitting a subsequent UDP communication from the control server to the recipient peer, when the control server requires the recipient peer to effect an outbound TCP communication.

12. The method of claim 1, wherein at least one communication, connection or transmission of data is effected over a secure communication using public-key encryption methodology, Secure Socket Layer (SSL) methodology, Transport Layer Security (TLS) methodology or any combination thereof.

13. A computer-implemented method for establishing an outbound Transmission Control Protocol (TCP) communication from a recipient peer, with at least one Internet Protocol (IP) address and at least one port, the method comprising the steps of:
(a) transmitting at least one identification request from the recipient peer over a User Datagram Protocol (UDP) communication to a control server, with at least one IP address and at least one port, the request including data sufficient for the control server to identify the recipient peer; and
(b) transmitting a subsequent UDP communication from the control server to the recipient peer, when the control server requires the recipient peer to effect an outbound TCP communication.

14. The method of claim 13, wherein the recipient peer is communicating through a recipient NAT box, the method further comprising the steps of:
periodically repeating the transmitting step (a); and
creating a mapping on the recipient NAT box for use in step (b).

15. A method of securely registering at least one peer, having at least one Internet Protocol (IP) address and at least port, with at least one control server, having at least one IP address and at least one port, the method comprising the steps of:
transmitting, by the at least one peer, a setup request to the at least one control server via a secure connection;
maintaining, by the control server, and for the at least one peer, a peer record, including: (i) peer identification data; (ii) an IP address of the peer sending the setup request; (iii) a time stamp indicating when the last message was received for the peer; (iv) an indication of whether the peer has securely registered; (v) the remote port from which a subsequent insecure communication is initiated, or any combination thereof; and
transmitting, by the control server, a reply to the peer via a secure connection, the reply including at least a portion of the peer identification data; and
establishing, by the peer, a port to use for the transmission of subsequent insecure communications.

16. The method of claim 15, wherein the peer identification data includes name information, identification number, generated random number, generated pseudo-random number, serial number or any combination thereof.

17. The method of claim 15, further comprising the steps of:
(a) transmitting at least one identification request from the peer over a User Datagram Protocol (UDP) communication to a control server, the request including data sufficient for the control server to identify the peer; and
(b) transmitting a subsequent UDP communication from the control server to the peer, when the control server requires the peer to effect an outbound TCP communication.

18. The method of claim 17, further comprising the step of periodically repeating the transmitting step (a).

19. The method of claim 17, further comprising the steps of:
matching, by the control server, the peer identification data, the IP address and, for non-initial matching, the port transmitted from the peer with the peer identification data, the IP address and, for non-initial matching, the port in the peer record;
if the peer identification data and IP addresses match, initially logging the port in the peer record for use in subsequent matching; and
if the peer identification data and IP addresses do not match:
(i) responding to the peer; and
(ii) requiring a new setup request from the peer.

20. The method of claim 15, wherein at least one communication, connection or transmission of data is effected over a secure communication using public-key encryption methodology, Secure Socket Layer (SSL) methodology, Transport Layer Security (TLS) methodology or any combination thereof.
